(19) United States
(12) Patent Application Publication
(10) Pub. No.: US 2018/0012202 A1
(43) Pub. Date: Jan. 11, 2018

(54) SYSTEM AND METHOD FOR PROVIDING ACH TRANSACTIONS BETWEEN ACCOUNTS THAT LIMITS FINANCIAL RISK TO FINANCIAL INSTITUTIONS

(71) Applicants: Jorge Jimenez, Roswell, GA (US); Evan Shelan, Pleasanton, CA (US)

(72) Inventors: Jorge Jimenez, Roswell, GA (US); Evan Shelan, Pleasanton, CA (US)

(21) Appl. No.: 15/646,704

(22) Filed: Jul. 11, 2017

Related U.S. Application Data
(60) Provisional application No. 62/360,636, filed on Jul. 11, 2016.

(51) Int. Cl. G06Q 20/10; G06Q 40/02

(52) U.S. Cl. CPC G06Q 20/10; G06Q 40/02

(57) ABSTRACT

A system and method of transferring funds between accounts. A customer (user) sends an ACH transaction request to transfer an amount of funds from a first account of a first financial institution to a second account of a second financial institution. The first financial institution generates a same day ACH transaction to transfer the amount of funds from the first account to a general ledger account of the first financial institution and at the same time or near the same time, the first financial institution generates a next day or more ACH transaction including a transfer of the amount of funds from the general ledger account of the first financial institution to the second bank account of the second financial institution. The next day or more ACH transaction is completed only if the same day ACH transaction is completed.

### CROSS-REFERENCE TO RELATED APPLICATION

This application claims the benefit of priority of U.S. provisional application No. 62/360,636, filed Jul. 11, 2016, the contents of which are herein incorporated by reference.

### BACKGROUND OF THE INVENTION

The present invention relates to financial transactions and, more particularly, to a system and method that reduces the risk of no-sufficient funds, for a financial institution's own customers before the financial institution authorizes an ACH transfer. The process facilitates the pre-funding of transactions by providing automation of the interactions between the Accounting Ledgers of Financial Institutions core-banking system and clearing house transactions between accounts that limits financial risk to financial institutions.

Financial institutions, such as banks, offer many products and services to their clients. One such service is the ability to process automated clearing house (ACH) transactions. For example, a corporate client of a bank may request its own bank to initiate an ACH credit. Typically, funds associated with the ACH credits are sent regardless of whether the customer has the funds in their account. Financial Institutions provide certain limits per customer through a risk-assessment.

As can be seen, there is a need for a system and method for providing automated clearing house transactions between accounts that limits financial risk to financial institutions.

### SUMMARY OF THE INVENTION

In one aspect of the present invention, a method of transferring funds comprises the steps of: receiving, by a first financial institute, a request to transfer an amount of funds from a first account of the first financial institution to a second account of a second financial institution, the request originating from a user; generating a same day automated clearing house (ACH) transaction by a computing system of the first financial institution, the same day ACH transaction comprising a transfer of at least the amount of funds from the first account to a general ledger account of the first financial institution; and generating a next day or more ACH transaction by the computing system of the first financial institution, the next day or more ACH transaction comprising a transfer of the amount of funds from the general ledger account of the first financial institution to the second account of the second financial institution, wherein the next day or more ACH transaction is completed only if the same day ACH transaction is completed.

In another aspect of the present invention, a computer-implemented method executed by an automated system for providing automated clearing house (ACH) transactions between accounts that limits financial risk to financial institutions comprising the steps of: receiving, from a user, a request to transfer an amount of funds from a first account of a first financial institution to a second account of a second financial institution through a web based interface of a computing system of the first financial institution, the computing system comprising a processor and a memory, wherein the processor: generates a same day automated clearing house (ACH) transaction comprising a transfer of at least the amount of funds from the first account to a general ledger account of the first financial institution; and generates a next day or more ACH transaction comprising a transfer of the amount of funds from the general ledger account of the first financial institution to the second account of the second financial institution, wherein the next day or more ACH transaction is completed only if the same day ACH transaction is completed.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention; and

FIG. 2 is a flow chart of an exemplary method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Banks and other financial institutions typically offer various services to their clients. One service that may be offered is the ability to process automated clearing house (ACH) transactions. For example, a bank may have one or more corporate clients, such as other companies or consumers. As a result, the corporate client may transmit the ACH credit transactions to the bank for processing.

After receiving ACH credit transactions from a corporate client, a bank processes the ACH credit transactions by transmitting them to an ACH operator such as a Federal Reserve Bank. Typically, however, the bank will not check the corporate client account's balance before sending the funds to the ACH operator. However, this may create unwanted risks for the bank because an ACH credit may be sent from an account holder with non-sufficient funds (NSF).

The teachings of the disclosure recognize that it would be desirable to provide ACH credit processing services to clients of a financial institution without creating unnecessary and unwanted risks to the financial institution due to NSF. The following system and method provides turn-key instructions to move funds by using Same Day ACH formats, so that the accounting system is able to move funds from the customer account (prefunding) to the bank General Ledger before releasing transactions to the ACH network.

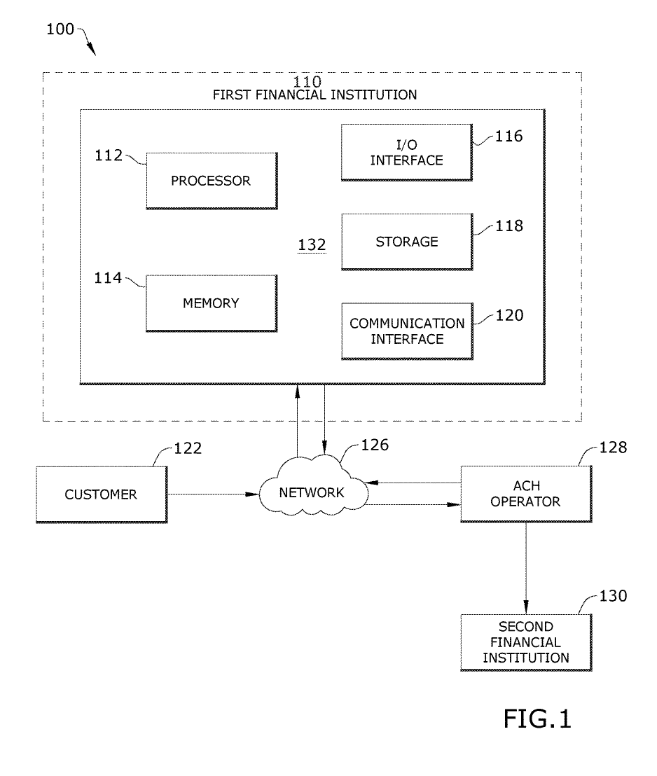

FIG. 1 illustrates a system 100 according to certain embodiments. The system 100 may include a first (originating) financial institution 110, one or more customers (users) 122, one or more computing systems 132, one or more ACH operators 128, and one or more second (receiving) financial institutions 130. The first financial institution 110, customers 122, ACH operators 128, and second financial institutions 130 may be communicatively coupled by a network 126. The first financial institution 110 and computing system 132 are generally operable to provide ACH services to customers 122, as described below.

In general, one or more computing systems 132 may offer ACH services to customers 122. The customer 122 first requests that the first financial institution 110 transfers an amount of funds from a first account of the first financial institution 110 to a second account of the second financial institution 130. After receiving the request from the customer 122, the computing system 132 generates a same day automated clearing house (ACH) transaction and a next day or more ACH transaction at or near the same time. The same day ACH transaction includes a transfer of at least the amount of funds from the first account to a general ledger account of the first financial institution 110. The next day or more ACH transaction includes a transfer of the amount of funds from the general ledger account of the first financial institution 110 to the second account of the second financial institution 130. The same day ACH transaction is sent first to the first financial institution 110 with an instruction to move funds from the first account to the general ledger account of the first financial institution 110. If no returns are received, then next day or more ACH transaction are sent to the ACH operator 128 over the network 126 to process or are processed by the financial institutions 110, 130. The amount of funds are transferred from the first account of the customer 122 to the general ledger account of the first financial institution 110 the same day. The amount of funds are transferred from the general ledger account of the first financial institution 110 to the second account of the second financial institution 130 the next day or later. The general ledger account of the first financial institution 110 has the funds in the account prior to sending the amount of funds to the second account, thereby mitigating the risk of the transaction of the first financial institution 110. If the same day ACH transaction is not completed within the same day, the next day or more ACH transaction is not delivered to the ACH for processing and therefore the transfer is cancelled.

In certain embodiments, the same day ACH transaction includes a transfer of the amount of funds and an amount in fees to the general ledger of the first financial institution 110. In such embodiments, the next day or more ACH transaction includes a first transaction and a second transaction. The first transaction includes the transfer of the amount of funds from the general ledger account of the first financial institution 110 to the second account of the second financial institution 130. The second transaction includes a transfer of the amount in fees from the general ledger account of the first financial institution 130 to a fee ledger account of the first financial institution 130. In such embodiments, both of the first and second transactions of the next day or more ACH transaction are placed in a queue until the next day or more. Therefore, the amount of funds are transferred from the general ledger account of the first financial institution 110 to the second account of the second financial institution 130 the next day or later and the fees are transferred from the general ledger account of the first financial institution 110 to the fee ledger account of the first financial institution 130 the next day or later.

The first financial institutions may refer to any financial institution such as a bank. The second financial institution 130 may refer to any other financial institution than the first financial institution 110. The customers 122 may refer to any client of the financial institution. For example, the customer may be an individual or a corporate client and may be any organization such as a business, corporation, firm, government entity, educational entity, or any other organization, regardless of the size of the organization. The customers 122 may utilize any appropriate device to interact with and request to transfer between accounts using the computing systems 132. In some embodiments, the customers 122 may utilize a computer, workstation, mobile computing devices, such as a smart phone or tablet, Internet browser, graphical user interface (GUI), electronic notebook, or any other suitable device (wireless, wireline, or otherwise), component, or element capable of receiving, processing, storing, or communicating information with other components of the system 100.

In certain embodiments, the network 126 may refer to any interconnecting system capable of transmitting audio, video, signals, data, messages, or any combination of the preceding. The network 126 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In certain embodiments, ACH operators 128 may refer to any operator that processes ACH transactions. In some embodiments, ACH operators or network 128 may be Federal Reserve Banks. In some embodiments, ACH operators 128 may be The Clearing House (TCH), formerly known as Electronic Payments Network (EPN). In certain embodiments, the first financial institution 110 may exchange ACH transactions directly with another financial institution such as the second financial institution, and is not limited to exchanging ACH transactions with ACH operators 128.

This disclosure contemplates any suitable number of computing systems 132. This disclosure contemplates the computing system 132 taking any suitable physical form. As example and not by way of limitation, the computing system 132 may be a virtual machine (VM), an embedded computing system, a system-on-chip (SOC), a single-board computing system (SBC) (e.g., a computer-on-module (COM) or system-on-module (SOM)), a desktop computing system, a laptop or notebook computing system, an interactive kiosk, a mainframe, a mesh of computing systems, a server, an application server, or a combination of two or more of these. Where appropriate, the computing system 132 may include one or more computing systems 132; be unitary or distributed; span multiple locations; span multiple machines; or reside in a cloud, which may include one or more cloud components in one or more networks. Where appropriate, one or more computing systems 132 may perform without substantial spatial or temporal limitation one or more steps of one or more methods described or illustrated herein. As an example and not by way of limitation, one or more computing systems 132 may perform in real time or in batch mode one or more steps of one or more methods described or illustrated herein. One or more computing systems 132 may perform at different times or at different locations one or more steps of one or more methods described or illustrated herein, where appropriate.

In some embodiments, the computing system 132 may execute any suitable operating system such as IBM's zSeries/Operating System (z/OS), MS-DOS, PC-DOS, MAC-OS, WINDOWS, UNIX, OpenVMS, an operating system based on LINUX, or any other appropriate operating system, including future operating systems. In some embodiments, the computing system 132 may be a web server running web server applications such as Apache, Microsoft's Internet Information Server™, and the like.

In particular embodiments, the computing system 132 includes a processor 112, memory 114, storage device 118, an input/output (I/O) interface 116, and a communication interface 120. In particular embodiments, the processor 112 includes hardware for executing instructions, such as those making up a computer program. The memory 114 includes main memory for storing instructions such as computer program(s) for the processor 112 to execute, or data for processor 112 to operate on. The storage device 118 includes mass storage for data or instructions such as the computer program. As an example and not by way of limitation, the storage device 118 may include an HDD, a floppy disk drive, flash memory, an optical disc, a magneto-optical disc, magnetic tape, a Universal Serial Bus (USB) drive, a solid-state drive (SSD), or a combination of two or more of these. The storage device 118 may include removable or non-removable (or fixed) media, where appropriate. The storage device 118 may be internal or external to computing system 132, where appropriate. In particular embodiments, the storage device 118 is non-volatile, solid-state memory.

The I/O interface 116 includes hardware, software, or both providing one or more interfaces for communication between the computing system 132 and one or more I/O devices. The system 100 may include one or more of these I/O devices, where appropriate. One or more of these I/O devices may enable communication between a person and the system 100. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. This disclosure contemplates any suitable I/O devices and any suitable I/O interfaces 116 for them.

The communication interface 120 includes hardware, software, or both providing one or more interfaces for communication (e.g., packet-based communication) between the computing system 132 and one or more other computing systems 132 or one or more networks. As an example and not by way of limitation, communication interface 120 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 120. As an example and not by way of limitation, the computing system 132 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the computing system 132 may communicate with a wireless PAN (WPAN) (e.g., a BLUETOOTH WPAN), a WI-FI network, a WI-MAX network, a cellular telephone network (e.g., a Global System for Mobile Communications (GSM) network), or other suitable wireless network or a combination of two or more of these. The computing system 132 may include any suitable communication interface 120 for any of these networks, where appropriate.

In operation, the computer program, upon execution by the processor 112, provides ACH services to the customer 122. To provide ACH services, the computer program may first generate the ACH transactions. In certain embodiments, the transactions may be transmitted through the network 126 using Network Data Mover (NDM), FTP, CONNECT:DIRECT, SWIFTAlliance Gateway (SAG), DATA EXPRESS, or any other suitable method for transmitting ACH transactions. In some embodiments, the ACH transactions may refer to a National Automated Clearing House Association (NACHA) formatted electronic file, ISO 20022 formats and the like that include one or more ACH transactions. As an example, the transactions may include one or more ACH transactions that indicate an amount of funds to collect from various accounts.

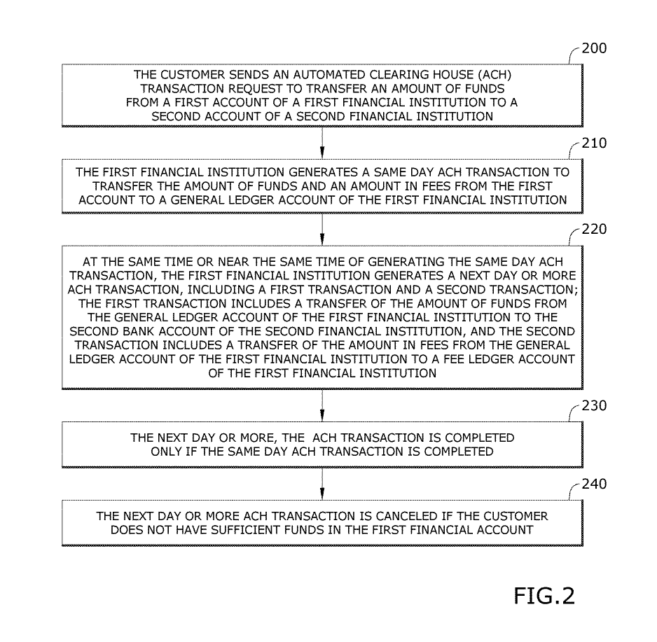

Referring to FIG. 2, a method of transferring funds between accounts may include the following steps: customer (user) sends an ACH transaction request to transfer an amount of funds from a first account of a first financial institution to a second account of a second financial institution 200; the first financial institution generates a same day ACH transaction to transfer the amount of funds and an amount in fees from the first account to a general ledger account of the first financial institution 210; at the same time or near the same time of generating the same day ACH transaction, the first financial institution generates a next day or more ACH transaction including a first transaction and a second transaction, the first transaction includes a transfer of the amount of funds from the general ledger account of the first financial institution to the second bank account of the second financial institution and the second transaction includes a transfer of the amount in fees from the general ledger account of the first financial institution to a fee ledger account of the first financial institution 220. The transfers are performed by an ACH operator or by the financial institutions. The next day or more ACH transaction is completed only if the same day ACH transaction is completed. The next day or more ACH transaction is canceled if the customer does not have sufficient funds in the first account. Since the funds are transferred from the first financial institution to the second account of the second financial institution after the first financial institution has transferred the amount of funds from the customer's account, the system and method of the present invention mitigates the risk of the transaction of the first financial institution. Further, the present invention is more efficient and effective when compared to other delayed transaction systems.

It should be understood, of course, that the foregoing relates to exemplary embodiments of the invention and that modifications may be made without departing from the spirit and scope of the invention as set forth in the following claims.

What is claimed is:

1. A method of transferring funds comprising the steps of:
receiving, by a first financial institute, a request to transfer an amount of funds from a first account of the first financial institution to a second account of a second financial institution, the request originating from a user;
generating a same day automated clearing house (ACH) transaction by a computing system of the first financial institution, the same day ACH transaction comprising a transfer of at least the amount of funds from the first account to a general ledger account of the first financial institution; and
generating a next day or more ACH transaction by a computing system of the first financial institution, the next day or more ACH transaction comprising a transfer of the amount of funds from the general ledger account of the first financial institution to the second account of the second financial institution, wherein
the next day or more ACH transaction is completed only if the same day ACH transaction is completed.

2. The method of claim 1, wherein the same day ACH transaction and the next day or more ACH transaction are generated at or near a same time.

3. The method of claim 1, wherein the transfer of the at least the amount of funds is a transfer of the amount of funds and an amount in fees.

4. The method of claim 3, wherein the next day or more ACH transaction comprises a first transaction and a second transaction, wherein the first transaction comprises the transfer of the amount of funds from the general ledger account of the first financial institution to the second account of the second financial institution and the second transaction comprises a transfer of the amount in fees from the general ledger account of the first financial institution to a fee ledger account of the first financial institution.

5. A computer-implemented method executed by an automated system for providing automated clearing house (ACH) transactions between accounts that limits financial risk to financial institutions comprising the steps of:
receiving, from a user, a request to transfer an amount of funds from a first account of a first financial institution to a second account of a second financial institution through a web based interface of a computing system of the first financial institution, the computing system comprising a processor and a memory, wherein the processor
generates a same day automated clearing house (ACH) transaction comprising a transfer of at least the amount of funds from the first account to a general ledger account of the first financial institution; and
generates a next day or more ACH transaction comprising a transfer of the amount of funds from the general ledger account of the first financial institution to the second account of the second financial institution, wherein
the next day or more ACH transaction is completed only if the same day ACH transaction is completed.

6. The method of claim 5, wherein the same day ACH transaction and the next day or more ACH transaction are generated at or near a same time.

7. The method of claim 5, wherein the transfer of the at least the amount of funds is a transfer of the amount of funds and an amount in fees.

8. The method of claim 7, wherein the next day or more ACH transaction comprises a first transaction and a second transaction, wherein the first transaction comprises the transfer of the amount of funds from the general ledger account of the first financial institution to the second account of the second financial institution and the second transaction comprises a transfer of the amount in fees from the general ledger account of the first financial institution to a fee ledger account of the first financial institution.
